(19) United States
(12) Patent Application Publication
(10) Pub. No.: US 2015/0231610 A1
(43) Pub. Date: Aug. 20, 2015

(54) SUPPORTED GOLD NANOPARTICLE CATALYST AND METHOD FOR PRODUCING SAME

(71) Applicant: National Institute of Advanced Industrial Science and Technology, Tokyo (JP)

(72) Inventors: Hiroaki Sakurai, Osaka (JP); Kenji Koga, Ibaraki (JP); Masato Kiuchi, Osaka (JP)

(73) Assignee: National Institute of Advanced Industrial Science and, Tokyo (JP)

(21) Appl. No.: 14/425,934

(22) PCT Filed: Sep. 2, 2013
(86) PCT No.: PCT/JP2013/073521

§ 371 Date: Mar. 4, 2015

(30) Foreign Application Priority Data
Sep. 4, 2012 (JP) 2012-194006

(51) Int. Cl. B01J 23/89; B01J 35/00; B01J 21/18; B01J 37/16; B01J 21/06; B01J 23/68; B01J 37/00; B01J 23/52; B01J 35/06

(52) U.S. Cl. CPC B01J 23/8913; B01J 23/52; B01J 35/0006; B01J 35/0013; B01J 35/006; B01J 21/18; B01J 35/06; B01J 21/063; B01J 23/688; B01J 37/0072; B01J 37/16

(57) ABSTRACT

The main problem addressed by the present invention is to provide a supported gold nanoparticle catalyst and having high catalytic activity. The above-mentioned problem can be solved by a supported catalyst comprising: a carrier having a reducing power; and gold nanoparticle with an average particle diameter of 100 nm or less, and preferably with an average particle diameters of 5 nm or less supported on the carrier. The present invention also provides a method for producing the supported catalyst.

### TECHNICAL FIELD

The present invention relates to a supported gold nanoparticle catalyst and having high catalytic activity and to a method for production thereof.

### BACKGROUND ART

There have been studies on applications of a gold nanoparticle catalyst, which has gold nanoparticles supported on the surface of a carrier, in a variety of fields. It is believed that such a catalyst can have higher catalytic performance by making gold smaller nanoparticles (e.g., 10 nm or less in average particle size) deposited on the carrier surface. Therefore, a variety of preparation methods for producing high catalytic performance have been studied.

Conventionally, impregnation methods (see, for example, Non-Patent Documents 1 and 2) are used to deposit a precious metal such as platinum, palladium, or rhodium as a catalytic component on a carrier. For example, an impregnation method for depositing platinum particles on a carrier includes impregnating the carrier with a chloroplatinic acid solution, then removing the solvent so that chloroplatinic acid is dispersed and deposited on the surface of the carrier, and performing calcination and reduction so that platinum fine particles are deposited on the carrier. Unfortunately, when impregnation methods are used, gold (Au) cannot be deposited in the form of fine particles on a carrier, so that a highly active catalyst cannot be obtained. To solve this problem, coprecipitation methods and deposition precipitation methods have been developed as methods for depositing gold nanoparticles and producing a highly active gold catalyst (see, for example, Non-Patent Documents 1 to 3). When these methods are used, gold can be deposited in the form of nanoparticles on the surface of a basic or amphoteric metal oxide. The resulting catalyst is drawing attention as a catalyst for new possibilities because it has unique low-temperature activity in CO oxidation reactions and also possesses unique characteristics, which is different from other precious metal catalysts, in various organic synthesis reactions.

On the other hand, carbon materials such as activated carbon and carbon black are widely used as carriers suitable for supporting catalytic components. These carbon materials have excellent characteristics such as a large surface area, a large adsorbing capacity for various substances, and high stability even under strongly acidic and basic conditions. For example, Pt/C and Pt—Ru/C catalysts are often used as electrode catalysts in fuel cells. These are catalysts obtained by supporting a large amount of a precious metal highly dispersed on the surface of carbon black. It is also known that Pt/C, Pd/C, Rh/C, and the like, having various precious metals supported on activated carbon, are useful as catalysts for liquid-phase organic synthesis.

However, the deposition precipitation method mentioned above are completely useless for the purpose of depositing gold nanoparticles on the surface of carbon materials. It is pointed out that this is because due to the high reducing power of carbon, gold ions in an aqueous solution can be easily reduced to coarse gold particles (Non-Patent Document 2). In studies on Au/C catalysts, therefore, a colloid immobilization method is often used, which includes preliminarily preparing a gold colloid in a liquid phase and then mixing the gold colloid with carbon so that gold is immobilized on the surface. Various other methods have also been developed, such as vacuum vapor deposition methods, deposition reduction methods using a gold ethylenediamine complex, and solid grinding methods with a dimethyl gold acetylacetonate complex (see, for example, Non-Patent Documents 1 to 4). However, it has been pointed out that even if gold nanoparticles are deposited on the surface of carbon by these methods, the adhesion of gold nanoparticles to the surface can be poor, a protective colloid such as PVP can remain to make it impossible to obtain the expected catalytic activity, or various problems with manufacturing equipment, material cost, treatment method, and so on can occur.

There has also been developed a method of depositing nanoparticles of Ag, Pd, or Au on a carbon material such as graphite or carbon nanotubes (Non-Patent Document 5). This method includes grinding and mixing a powder of a metal acetate such as silver acetate and a powder of a carbon material using a ball mill and thermally decomposing the acetate on the surface of a material with high thermal conductivity, such as carbon, based on a mechanochemical mechanism (which seems to be based on friction) so that the metal (such as Ag) is deposited in the form of nanoparticles. However, in this method, both the metal acetate and the carbon material, which are to be ground and mixed, need to be in the form of a powder. Therefore, granular or fibrous activated carbon cannot be used in this method. In addition, the grinding and mixing conditions are limited to dry conditions so that friction-induced heat generation can be highly efficient. The literature also does not show any example where particles of any precious metal supported on a carbon material are used as a catalyst. It is also expected that if the thermal decomposition of the acetate is not complete in the process of grinding and mixing, precious metal particles cannot be produced enough, so that high catalytic activity cannot be obtained due to the remaining organic substance such as acetate ions.

A method that includes using a metal oxide as a carrier and depositing a precious metal on the carrier by using the reducing power of the metal oxide has also been reported. For example, there is a method which includes reducing chloroplatinic acid to Pt by using a reducing power produced on the surface by the function of a photocatalyst such as titanium oxide so that Pt is deposited on the surface. This method is called photodeposition. However, it is pointed out that if this method is used to deposit gold on a metal oxide, ultraviolet irradiation is required, and relatively coarse gold particles of more than 5 nm can be easily formed (Non-Patent Document 2).

The inventors have previously developed a method that includes boiling and refluxing a colloidal gold acetate dispersion under basic conditions to form a solution containing completely dissolved gold; and impregnating a carrier with the solution to deposit small gold particles on the carrier (see, for example, Non-Patent Document 6). This method enables the deposition of gold nanoparticles on a wider variety of oxides, including acidic oxides, than the deposition precipitation methods. Thus, the inventors have tried to deposit small gold particles on a carrier with a reducing power, such as activated carbon, by using this method. Concerning the catalyst obtained by this method, however, the activity was not sufficiently increased after the deposition of gold although catalytic activity for glucose oxidation reaction is confirmed. Thus, it was necessary to investigate on the methods for producing a supported catalyst with higher activity.

It has been reported that supported gold nanoparticle catalyst can have high activity and selectivity for various liquid-phase reactions such as oxygen-based oxidation of glucose to gluconic acid. They are also expected to be useful as catalysts for such synthetic processes. Thus, there has been a demand for a supported gold nanoparticle catalyst and having high catalytic activity and a method for obtaining such a supported catalyst.

### PRIOR ART DOCUMENTS

### Non-Patent Documents

Non-Patent Document 1: Takashi Takei, Gold Nanotechnology: Fundamentals and Applications, Chapter 9, Supervised by Masatake Haruta, CMC Publishing, pp. 116-126 (2009)

Non-Patent Document 2: G. C. Bond, C. Louis, D. T. Thompson, Catalysis by Gold (Chapter 4), Imperial College Press, London, pp. 72-120 (2006)

Non-Patent Document 3: Masatake Haruta, Gold Nanotechnology: Fundamentals and Applications Chapter 8, Supervised by Masatake Haruta, CMC Publishing, pp. 107-115 (2009)

Non-Patent Document 4: Tamao Ishida, Gold Nanotechnology: Fundamentals and Applications, Chapter 10, Supervised by Masatake Haruta, CMC Publishing, pp. 127-134 (2009)

Non-Patent Document 5: Yi Lin et al., J. Phys. Chem. C 2009, 113, 14858-14862

Non-Patent Document 6: Hiroaki Sakurai, Kenji Koga, Takae Takeuchi, Masato Kiuchi, the Abstract of the 108th Meeting of Catalysis Society of Japan, 3F09 (2011)

### SUMMARY OF THE INVENTION

### Problems to be Solved by the Invention

It is a principal object of the present invention to provide a supported gold nanoparticle catalyst with an average particle size of 100 nm or less and having high catalytic activity and to provide a method for producing such a supported catalyst.

### Means for Solving the Problem

As a result of diligent studies for solving the problems, the inventors found that when an activated carbon powder was added to a colloidal gold acetate dispersion, which was produced by dispersing gold acetate in water, and then stirred for a while, the supernatant became completely clear, and gold ions became undetectable. This seemed to be because gold was deposited on the activated carbon. The inventors further separated the activated carbon powder from the colloidal gold acetate dispersion by filtration, washing the powder with water, drying the powder, and subjecting the powder to the measurement of the catalytic activity in a glucose oxidation reaction. As a result, the inventors found that the gold/activated carbon catalyst obtained by such a process had very high catalytic activity. As a result of further studies based on these findings, the present invention has been accomplished. Specifically, the present invention provides a supported catalyst and a method for production thereof as follows.

Item 1. A supported catalyst including: a carrier having a reducing power; and gold nanoparticles with an average particle size of 100 nm or less supported on the carrier.

Item 2. The supported catalyst according to item 1, wherein the gold nanoparticles have an average particle size of 10 nm or less.

Item 3. The supported catalyst according to item 1 or 2, wherein the carrier having a reducing power is a porous material.

Item 4. The supported catalyst according to any one of items 1 to 3, wherein the carrier having a reducing power is a carbon material or a metal oxide.

Item 5. The supported catalyst according to any one of items 1 to 4, wherein the carrier having the reducing power is at least one selected from the group consisting of powdered activated carbon, fibrous activated carbon, titanium oxide, cobalt oxide, and manganese oxide.

Item 6. A method for producing a supported gold nanoparticle catalyst with an average particle size of 100 nm or less, the method including the step of bringing a gold carboxylate and a carrier having a reducing power into contact with each other in the presence of water.

Item 7. The method according to item 6, which includes the steps of:

(i) dispersing the gold carboxylate in water to form a colloidal gold carboxylate dispersion; and

(ii) bringing the colloidal gold carboxylate dispersion obtained in the step (i) and the carrier having a reducing power into contact with each other to deposit gold nanoparticles on the carrier.

Item 8. The method according to item 7, wherein in the step (ii), a reducing agent is further added to the colloidal gold carboxylate dispersion.

Item 9. The method according to item 7 or 8, wherein in the step (ii), a protective colloid is further added to the colloidal gold carboxylate dispersion.

Item 10. The method according to any one of items 6 to 9, wherein the gold carboxylate is gold acetate.

### Advantages of the Invention

The supported catalyst provided according to the present invention includes gold nanoparticles supported on the carrier having a reducing power and has high catalytic activity. A supported gold nanoparticle catalyst and having high catalytic activity can be more easily obtained by the supported catalyst-producing method according to the present invention than by conventional methods.

### BRIEF DESCRIPTION OF THE DRAWINGS

FIG. 1 is a flow chart illustrating the preparation process of supported catalyst according Examples 1 to 5 and Comparative Examples 1 to 3.

FIG. 2 is a chart illustrating the results of powder X-ray diffraction of gold/activated carbon prepared in Example 1.

FIG. 3 is a transmission electron microscope (TEM) photograph of gold/titanium oxide prepared in Example 8 and a graph illustrating the size distribution of gold nanoparticles.

### EMBODIMENTS OF THE INVENTION

1. Supported Gold Nanoparticle Catalyst

The supported catalyst of the present invention includes a carrier having a reducing power and gold nanoparticles with an average particle size of 100 nm or less supported on the carrier.

The supported catalyst of the present invention includes supported gold (Au) nanoparticles as a component showing catalytic activity. In the present invention, the average particle size of the gold nanoparticles is 100 nm or less, preferably 80 nm or less, more preferably 50 nm or less, even more preferably 10 nm or less, further more preferably 5 nm or less.

In the description, the average particle size refers to the volume average particle size when a carbon material is used as the carrier as described below. As used herein, the term “volume average particle size” refers to the average particle size (crystallite diameter in the strict sense) as determined using powder X-ray diffraction (XRD) and the Scherrer equation (specific measurement conditions and calculation methods are shown in the examples below).

On the other hand, when a metal oxide is used as the carrier as described below, the average particle size refers to the number average particle size. As used herein, the term “number average particle size” refers to the value as determined from a size distribution obtained by transmission electron microscope (TEM) observation.

It is reported that when a catalyst having supported gold nanoparticles with an average particle size of 10 nm, in particular, 5 nm or less is used in a glucose oxidation reaction and a carbon monoxide oxidation reaction, the reactivity sharply increases with decreasing particle size (see, for example, Hironori Ohashi, Gold Nanotechnology: Fundamentals and Applications, Chapter 8, Supervised by Masatake Haruta, CMC Publishing, pp. 220-234 (2009); Hiroko Okatsu et al., Applied Catalysis A: General, 369 (2009) pp. 8-14). Therefore, the average particle size of the supported gold nanoparticles can be estimated by using a glucose oxidation reaction or a carbon monoxide oxidation reaction. The catalytic activity (reaction rate (mol s⁻¹mol_{Au}⁻¹)) in the glucose oxidation reaction can be determined as follows. Using the supported gold nanoparticle catalyst, glucose is oxidized to generate gluconic acid. The generated gluconic acid is neutralized by titration with sodium hydroxide. The gluconic acid production rate (mol s⁻¹) per reaction time (s) can be determined from the added amount (mol s⁻¹) of sodium hydroxide. The catalytic activity (reaction rate (mol s⁻¹ mol_{Au}⁻¹)) in the carbon monoxide oxidation reaction can be determined as follows. Using the supported gold nanoparticle catalyst, carbon monoxide is oxidized to generate carbon dioxide. The CO conversion ratio is calculated from analysis values of CO and CO₂ concentrations. The reaction rate is calculated from the values. Test Examples 1 and 2 below show specific conditions of the glucose and carbon monoxide oxidation reactions and specific methods for calculating the catalytic activity (reaction rate (mol s⁻¹mol_{Au}⁻¹)), respectively. Test Examples 1 and 2 also show specific reaction rates (mol s^{-l}mol_{Au}⁻¹) per amount of supported Au for gold particle sizes of 10 nm or less, which are calculated from the reaction conditions in each test example. Specifically, when the glucose oxidation reaction is performed under the conditions shown in Test Example 1, a reaction rate of 1 mol s⁻¹mol_{Au}⁻¹ or more suggests that the supported gold nanoparticles have a particle size of 10 nm or less. When the carbon monoxide oxidation reaction is performed under the conditions shown in Test Example 2, a reaction rate of 0.0053 mol s⁻¹mol_{Au}⁻¹ or more suggests that the supported gold nanoparticles have a particle size of 10 nm or less.

In the present invention, the supported catalyst may have any number of gold nanoparticles as long as the desired catalytic activity is obtained. For example, gold nanoparticles with an average particle size of 10 nm or less, preferably 5 nm or less may exist at an average density of 5 or more, preferably 10 or more, per 10,000 nm² (100 nm square) carrier surface area. The density of the supported gold nanoparticles can be determined by performing TEM observation in which the number of gold nanoparticles present in a certain area is counted.

The fraction of the number of supported gold nanoparticles with an average particle size of 10 nm or less, preferably 5 nm or less, is also not restricted as long as the desired catalytic activity is obtained. For example, the fraction of the number of gold nanoparticles with an average particle size of 10 nm or less, preferably 5 nm or less, may be 10% or more, preferably 30% or more, more preferably 50% or more. The fraction of the number can also be determined by TEM observation in which what percentage the particles with an average particle size of 10 nm or less (or 5 nm or less) make up of gold particles in a certain area is calculated.

In the present invention, the carrier having a reducing power acts as an electron donor to gold(III) ions when the carrier is brought into contact with a colloidal gold carboxylate dispersion in the method described below for producing a supported gold nanoparticle catalyst. In other words, the carrier having a reducing power in the present invention refers to a carrier that can reduce, to zero-valent metallic gold on its surface, a small amount of gold(III) ions dissolved in a colloidal gold carboxylate dispersion and can deposit the metallic gold at the same time.

The carrier having a reducing power used in the present invention may also be, for example, a carbon material, a metal oxide, or the like. More specifically, the carbon material may be activated carbon, carbon black, carbon nanotubes, carbon nanofibers, carbon nanohorns, graphite, or the like. The metal oxide may be a metal oxide having a photocatalytic function, such as titanium oxide (TiO₂), zinc oxide (ZnO), or tungsten oxide (WO₃); or tricobalt tetraoxide (Co₃O₄), triiron tetraoxide (Fe₃O₄), manganese monoxide (MnO), cuprous oxide (Cu₂O), manganese ferric oxide (manganese ferrite, MnFe₂O₄), or any other metal oxide having a low-valent transition metal ion capable of being easily oxidized by reaction with Au(III) ions, such as Co(II), Fe(II), Mn(II), or Cu(I). These carriers may be used singly or in combination of two or more.

The metal oxide having a photocatalytic function, which may be used in the present invention, is an oxide that exhibits a catalytic activity when irradiated with light. For example, when electrons in titanium oxide or the like are excited by light, electrons having a relatively strong reducing power and holes having a very strong oxidizing power are generated to allow a chemical substance adsorbed on the surface to undergo an oxidation-reduction reaction. In the present invention, the action to reduce trivalent gold ions to zero-valent metallic gold is used to deposit metallic gold on a metal oxide. In general, when applied to a photocatalyst, ultraviolet light can cause a reaction very quickly, although visible light can also cause a reaction. In the present invention, however, the application of ultraviolet light may cause a reduction reaction to proceed too quickly so that coarse gold particles may be rather formed. In the present invention, enough effectiveness can be obtained even by indoor light.

The metal oxide containing a low-valention, which may be used in the present invention, is an oxide containing a low-valent transition metal ion capable of being easily oxidized to a high-valent species. Examples of the low-valent transition metal ion include Cu(I), Ti(II), V(II), Cr(II), Mn(II), Fe(II), Co(II), etc. For example, in the case of Cu(I) as the low-valent transition metal ion, when brought into contact with Au(III), Cu(I) reduces it to Au(O) and is oxidized to Cu(II). The oxide containing any of these low-valent transition metal ions may be a simple oxide such as Cu₂O, a mixed valence oxide such as Fe₃O₄ (which contains both Fe(II) and Fe(III) ions), or a complex oxide such as MnFe₂O₄ (which contains both Mn(II) and Fe(III) ions). For example, commercially available manganese dioxide, which is generally expressed as MnO₂, is actually a non-stoichiometric compound having a certain composition such as MnOₓ (x=1.93-2.00). Therefore, commercially available manganese dioxide contains low-valent manganese with a valence of less than 4. When used in the present invention, the metal oxide containing a low-valent ion may also be an oxide containing such a substantially low-valent ion.

In the present invention, the carrier is preferably a porous material so that it can support a large amount of gold nanoparticles. The porous material may be of any type having a surface area of about 1 m²/g or more, such as activated carbon or a metal oxide with a primary particle size of about 50 nm or less. Preferred examples of the porous material include activated carbon, titanium oxide, cobalt oxide, manganese oxide, etc.

In the present invention, activated carbon is advantageously used as the carrier. Activated carbon is inexpensive and has a remarkably high specific surface area. Therefore, the gold nanoparticles can be efficiently deposited on activated carbon. Activated carbon (porous carbon material) is also generally known as a substance having a reducing power.

Activated carbon is generally produced by subjecting carbon-based materials to an activation treatment. Examples of carbon-based materials include wood, sawdust, charcoal, coconut shell, cellulose-based fibers, synthetic resin (such as phenolic resin), mesophase pitch, pitch coke, petroleum coke, coal coke, needle coke, polyvinyl chloride, polyimide, polyacrylonitrile, etc. The activation treatment may be generally a gas activation treatment (such as a water vapor activation treatment) or a chemical activation treatment, which is used to form pores in the surface of carbon-based materials so that they can have an increased specific surface area and an increased pore volume. Methods and conditions for these activation treatments are conventionally known. In the present invention, any type of activated carbon produced by any of these activation treatments may be used. Activated carbon obtained using any of the above raw materials (carbon-based materials) and any of the above activation treatments may be used as the carrier in the present invention.

Determinants for the adsorption ability of activated carbon include specific surface area, pore volume, and the surface chemical properties of activated carbon. When used as the carrier in the present invention, activated carbon typically has a specific surface area of 200 m²/g or more, preferably 500 m²/g or more, more preferably 1,000 m²/g or more, although the specific surface area may be at any level where at least gold nanoparticles can be deposited and the desired catalytic activity can be achieved. The upper limit of the specific surface area may be, but not limited to, about 3,300 m²/g, which is the upper limit of the specific surface are of commonly available activated carbon. The specific surface area of activated carbon is the value determined by the BET method in which a nitrogen adsorption isotherm is measured.

In the present invention, the pore volume of activated carbon used as the carrier is typically, but not limited to, 0.1 cm³/g or more, preferably 0.1 to 2 cm³/g, more preferably 0.5 to 1.5 cm³/g. The pore volume of activated carbon is the value measured by the nitrogen adsorption method.

The activated carbon used in the present invention may also have surface functional groups, the type and amount of which are modified by surface oxidation treatment or chemical addition. The surface functional groups may be carboxyl, carbonyl, phenolic hydroxyl (—OH), or the like. More specifically, carboxyl groups can be formed on the surface by a liquid-phase oxidation treatment with nitric acid. Carboxyl or carbonyl groups can also be formed by a gas-phase oxidation treatment with ozone. Phenolic hydroxyl groups can also be formed by gas-phase oxidation with air. Other surface functional groups can also be introduced or modified by known methods.

The carrier used in the supported catalyst of the present invention may be of any shape. The shape of the carrier may be appropriately selected depending on the type of the carrier, the intended use of the supported catalyst, and other factors. For example, the carrier may be used in the form of a powder, granules, pellets, or fibers. In the present invention, for example, the carrier is preferably in the form of a powder or fibers.

For example, when the carrier is used in the form of a powder, its particle size is typically such that it passes through a standard sieve with a nominal aperture size of 300 μm, preferably 125 μm, according to JIS Z 8801, although the carrier may have any particle size as long as it can carry gold nanoparticles.

More specifically, in the supported catalyst of the present invention, the carrier is preferably powdered activated carbon, granular activated carbon, fibrous activated carbon (activated carbon fibers), titanium oxide, cobalt oxide, or manganese oxide, more preferably, powdered activated carbon, fibrous activated carbon, titanium oxide, cobalt oxide, or manganese oxide.

Fibrous activated carbon (also called activated carbon fibers (ACFs)) is a type of activated carbon, which has a large number of pores suitable for adsorption in the surface while maintaining the fibrous form with a fiber diameter of 1 to 30 μm and an average fiber length of several mm or more. Therefore, fibrous activated carbon is particularly suitable for use in filter-shaped adsorbents and catalysts. Also in the supported catalyst of the present invention, gold nanoparticles can be supported on the surface of fibrous activated carbon while its fibrous shape is maintained.

In another mode, the supported catalyst of the present invention may include a support, a carrier immobilized on the support, and gold nanoparticles supported on the carrier. The support may be of any type capable of immobilizing the supported catalyst of the present invention. For example, the support may be in the form of a flat sheet, a block, fibers, a net, beads, a honeycomb, or the like. The support may also be made of any material as long as it is stable under the conditions for depositing gold nanoparticles and catalytic reactions. For example, various ceramics of any kind may be used to form the support.

In some cases, the material for use as the carrier contains a large amount of chloride ions depending on the manufacturing method. In such cases, chloride ions are preferably removed as much as possible by performing hot water cleaning or other processes in advance. This is because if chloride ions coexist during the preparation, gold nanoparticles can aggregate to form coarse particles. If necessary, the material for use as the carrier may be pulverized so that it can have higher dispersibility in the gold carboxylate-containing liquid.

The amount of the gold nanoparticles (namely, the amount of supported gold) in the supported catalyst of the present invention is typically from 0.0001 to 50% by weight, preferably from 0.001 to 10% by weight, more preferably from 0.05 to 5% by weight, even more preferably from 0.05 to 1.5% by weight. When the gold nanoparticles are supported in an amount within such ranges, higher catalytic activity can be achieved.

The method for depositing gold nanoparticles as the active catalytic component on the carrier having a reducing power will be described in detail in the section below “2. Method for preparing supported gold nanoparticle catalyst.”

The supported catalyst of the present invention, which includes supported gold nanoparticles with an average particle size of 100 nm or less, has high catalytic activity. The supported catalyst with such features can be effectively used in a variety of fields where gold nanoparticle catalysts are conventionally used, such as indoor air cleaning including oxidation and removal of carbon monoxide; atmospheric environment preservation including NOx reduction; fuel cell-related reactions including selective oxidation of carbon monoxide in hydrogen gas; and chemical process reactions such as reactions for the synthesis of propylene oxide from propylene.

2. Method for Preparing Supported Gold Nanoparticle Catalyst

The present invention provides a method for producing a supported gold nanoparticle catalyst with an average particle size of 100 nm or less, the method including the step of bringing a gold carboxylate and a carrier having a reducing power into contact with each other in the presence of water.

The present invention provides a method for producing a supported gold nanoparticle catalyst with an average particle size of 100 nm or less, the method more preferably including the following steps:

(i) dispersing a gold carboxylate in water to form a colloidal gold carboxylate dispersion; and

(ii) bringing the colloidal gold carboxylate dispersion obtained in the step (i) and a carrier having a reducing power into contact with each other to deposit gold nanoparticles on the carrier.

Step (i)

In the step (i), a gold carboxylate is used as a source for supplying gold nanoparticles. The gold carboxylate refers to carboxylated gold, preferably carboxylated trivalent gold. When dispersed in water, the gold carboxylate is partially dissolved and dissociated into an anion represented by formula (a) below and a gold ion (Au³⁺). Therefore, the colloidal gold carboxylate dispersion prepared in the production method of the present invention contains, in the solvent (water), colloidal gold nanoparticles, the dissolved gold carboxylate, and the gold ion and the anion represented by formula (a) below, which are dissociated from the dissolved gold carboxylate.

R—COO⁻ (a)

In the formula, R represents a hydrogen atom or a linear or branched alkyl group of 1 to 4 carbon atoms.

In the description, the anion represented by formula (a) is called “carboxylate.”

In the formula, R represents hydrogen or a linear or branched alkyl group of 1 to 4 carbon atoms, preferably 1 to 2 carbon atoms, more preferably one carbon atom. Specifically, the alkyl group may be methyl, ethyl, propyl, isopropyl, butyl, isobutyl, or tert-butyl, preferably methyl. The anion represented by formula (a) is preferably an acetate ion (CH₃COO⁻).

Examples of the gold carboxylate include Au(CH₃COO)₃, Au(C₂H₅COO)₃, Au(HCOO)₃, etc. The gold carboxylate may contain a basic salt such as Au(OH)(CH₃COO)₂ or Au(OH)₂(CH₃COO). These gold carboxylates may be used singly or in combination of two or more. Among these gold carboxylates, gold acetate (Au(CH₃COO)₃) is preferred because it is easily available and has a suitable level of solubility in water. When the gold carboxylate is used as a source for supplying gold nanoparticles, there is no need to be concerned about the residual halide (particularly, chloride), which can act as a catalyst poison.

In the production method of the present invention, water is used as a solvent in which the gold carboxylate is dispersed. The water to be used is preferably, but not limited to, water free of impurities such as chloride, examples of which include distilled water, ion-exchanged water (deionized water), distilled deionized water, purified water, pure water, and ultrapure water.

In the step (i), the method for dispersing the gold carboxylate in water may be appropriately selected from methods commonly used to disperse particles in water. For example, a magnetic stirrer, a vortex mixer, an ultrasonic cleaner, or the like may be used. These apparatuses may also be used in any combination. Examples of dispersing conditions include, but are not limited to, ultrasonic cleaner treatment (60 seconds), vortex mixer treatment (240 rmp, 10 seconds), etc. Any of these treatments may be repeated multiple times (for example, once to 20 times, preferably five to 10 times). The temperature during the dispersion is typically, but not limited to, 0 to 80° C., preferably 0 to 60° C., more preferably 10 to 40° C.

The colloidal gold carboxylate dispersion may contain the gold carboxylate at any concentration necessary to form the desired supported catalyst. In view of the stability of the colloidal dispersion, the content of the gold carboxylate in the dispersion is generally 1×10⁻⁴ to 20% by weight, preferably 1×10⁻³ to 10% by weight, more preferably 1×10⁻³ to 5% by weight in terms of metallic gold content. The amount of the gold carboxylate dispersed in water may be adjusted so that the concentration can fall within such ranges.

The pH of the colloidal dispersion may be at any level as long as the gold carboxylate can be uniformly dispersed. If necessary, for example, the pH of the colloidal dispersion may be adjusted to fall within the range of 1 to 8, preferably within the range of 2 to 8, more preferably within the range of 2 to 7.

A conventionally known pH adjusting agent may be used to adjust the pH of the colloidal dispersion within the range. Examples of the pH adjusting agent include hydrochloric acid, acetic acid, sulfuric acid, potassium hydroxide, calcium hydroxide, sodium hydroxide, etc.

If necessary, a protective colloid may also be added to the dispersion. The protective colloid may be appropriately selected from conventionally known materials such as polyvinylpyrrolidone (PVP), polyvinyl alcohol, polyethylene glycol, polyacrylic acid, sodium polyacrylate, gelatin, starch, dextrin, carboxymethyl cellulose, methyl cellulose, ethyl cellulose, and glutathione. Among them, polyvinylpyrrolidone, polyethylene glycol, polyacrylic acid, sodium polyacrylate, polyvinyl alcohol, and carboxymethyl cellulose are preferred, and polyvinylpyrrolidone and polyvinyl alcohol are more preferred. These protective colloids may be used singly or in combination of two or more.

The protective colloid may be denatured or modified as long as the effects of the present invention are not impaired. When a polymer is used as the protective colloid, the molecular weight is not particularly limited as long as the present invention remains effective. For example if polyvinylpyrrolidone is used, include PVP K-15 (10,000 in average molecular weight), PVP K-30 (40,000 in average molecular weight), and PVP K-90 (360,000 in average molecular weight) manufactured by KISHIDA CHEMICAL Co., Ltd.

The protective colloid may be added in any amount as long as the effects of the present invention are not impaired. For example, the protective colloid may be added in an amount of 0.01 to 50% by weight, preferably 0.1 to 20% by weight, based on the weight of the colloidal gold carboxylate dispersion.

A reducing agent may be further added to the dispersion. The reducing agent may be appropriately selected from conventionally known materials such as primary hydroxyl group-containing alcohols such as methanol, ethanol, 1-propanol, and ethylene glycol; secondary hydroxyl group-containing alcohols such as 2-propanol and 2-butanol; glycerin and other alcohols having both primary and secondary hydroxyl groups; aldehydes such as formaldehyde and acetaldehyde; saccharides such as glucose, fructose, glyceraldehyde, lactose, arabinose, and maltose; organic acids and salts thereof, such as citric acid, sodium citrate, potassium citrate, magnesium citrate, ammonium citrate, tannic acid, ascorbic acid, sodium ascorbate, and potassium ascorbate; boron hydride and salts thereof, such as sodium borohydride and potassium borohydride; and hydrazine and salts thereof, such as hydrazine, hydrazine hydrochloride, and hydrazine sulfate. These reducing agents may be used singly or in combination of two or more. Among these reducing agents, alcohols having a primary hydroxyl group and/or a secondary hydroxyl group and organic acid salts are preferred, and ethanol, methanol, and magnesium citrate are more preferred.

Some types of protective colloids can also be used as reducing agents. Among the above protective colloids, polyvinylpyrrolidone, polyvinyl alcohol, polyethylene glycol, gelatin, starch, dextrin, carboxymethyl cellulose, methyl cellulose, and ethyl cellulose can also be used as reducing agents. Among them, polyvinylpyrrolidone, polyethylene glycol, polyacrylic acid, sodium polyacrylate, polyvinyl alcohol, and carboxymethyl cellulose are preferred, and polyvinylpyrrolidone and polyvinyl alcohol are more preferred because they can form a more stable colloidal gold carboxylate dispersion.

The reducing agent may be added in any amount as long as the effects of the present invention are not impaired. For example, the reducing agent may be added in an amount of 0.01 to 90% by weight, preferably 0.1 to 60% by weight, based on the weight of the colloidal gold carboxylate dispersion. When a reducing agent is used in the present invention, the carrier needs to be added before the gold carboxylate is completely reduced to metallic gold by the reducing agent. Preferably, the reducing agent and the carrier are added at the same time to the colloidal gold carboxylate dispersion. When the reducing agent is used in combination, the gold nanoparticles can be deposited more efficiently on the carrier, so that a larger amount of gold can be supported.

The fact that the gold carboxylate is dispersed in a colloidal state can be confirmed by the Tyndall effect shown by sampling the solution into a test tube or the like and applying light from the side.

Step (ii)

In the step (ii), a carrier having a reducing power is brought into contact with the colloidal gold carboxylate dispersion obtained in the step (i), so that gold nanoparticles are deposited on the carrier.

Examples of the method for bringing the carrier having a reducing power into contact with the colloidal gold carboxylate dispersion include, but are not limited to, a method of using the dispersion in an excess amount of the volume of the carrier when the carrier is brought into contact with the dispersion; and a method of bringing the carrier into contact with the dispersion by adding, dropwise to the carrier, a solution in an amount proportional to the pore volume of the carrier like a type of impregnation method called incipient wetness method.

When the carrier having a reducing power is brought into contact with the colloidal gold carboxylate dispersion, the amount of the carrier may be appropriately adjusted based on the amount of metallic gold to be supported in the supported catalyst and the concentration of gold in the colloidal dispersion. For example, the amount of the carrier may be 1 to 10,000 parts by weight, preferably 10 to 10,000 parts by weight, more preferably 20 to 1,000 parts by weight, based on 1 part by weight of metallic gold.

If necessary, stirring may be performed when the carrier is brought into contact with the colloidal dispersion. The temperature during the impregnation is not limited to, but typically 1 to 80° C., preferably 5 to 60° C., more preferably 10 to 60° C.

In another mode of the method of the present invention, the steps (i) and (ii) may be performed at the same time. For example, water is added to a mixture of the gold carboxylate (preferably powdered gold carboxylate) and the carrier to form a slurry or paste, which is then kneaded. This process can achieve both of the purposes of dispersing the gold carboxylate in water and facilitating the contact between the gold carboxylate and the carrier.

When the steps (i) and (ii) are performed at the same time, the amount of the gold carboxylate is not limited as long as the amount provides a necessary concentration for the production of the desired supported catalyst. The content of the gold carboxylate is generally 1×10⁻⁴ to 90% by weight, preferably 1×10⁻³ to 80% by weight, more preferably 1×10⁻³ to 50% by weight in terms of metallic gold content. The amount of water to be mixed with the gold carboxylate may be adjusted so that such an amount can be provided.

The gold carboxylate powder and the carrier may be mixed and kneaded by any method capable of bringing them into contact with each other and depositing metallic gold nanoparticles on the carrier. For example, the gold carboxylate, water, and the carrier may be placed in a mortar and then ground with a pestle. Alternatively, the gold carboxylate, water, the carrier, and other materials may be placed in a mixer or the like and then stirred and mixed together.

These processes allow the carrier, the gold nanoparticles deposited on the carrier surface, the carboxylate anion, and water to coexist. Therefore, supported gold nanoparticles can be obtained by subjecting them directly to drying and other processes for removing water. Without particular limitation as a method of removing water, water may be removed by any conventionally known method such as filtration. Drying may also be performed by any method without particular limitation. The drying temperature may be, for example, from about 10 to about 150° C. Drying under reduced pressure, freeze drying, or other processes may also be performed to achieve the removal of water and drying at the same time.

However, if the carboxylate anion remains on the surface, it may interfere with the catalytic activity. If necessary, therefore, the carboxylate anion may also be removed. The carboxylate anion may be removed by a combustion removal method that includes performing a heat treatment (e.g., at 100 to 400° C. for 10 to 300 minutes) in the air after the drying, a method of performing water washing before the drying, or other methods. Examples of the method of removing the carboxylate anion by water washing include a method of performing water washing on a paper filter using a suction filtration apparatus while pouring water (preferably deionized water or distilled deionized water); and a method of performing water washing while separating water from the precipitate with a centrifuge. When the supported catalyst is in the form of a powder, a decantation method may also be used in which the supported catalyst power and water (preferably deionized water) are added to a vessel such as a beaker and the supernatant is replaced while washing.

Although the present invention should not be limitedly construed, it is conceivable that in the method of the present invention, most of the gold carboxylate dispersed in the gold carboxylate dispersion is dispersed as it is. It is conceivable that for example, when gold acetate Au(CH₃COO)₃ is used as a source for supplying gold, the following substances coexist: (a) colloidal gold acetate Au(CH₃COO)₃ particles (which are not soluble enough and dispersed as colloidal fine particles in water. This can be expected from the fact that the dispersion is colored brown.); (b) part of gold acetate Au(CH₃COO)₃ that is dissolved but not dissociated (gold acetate has a solubility of about 10⁻⁵ mol/L (see, for example, Non-Patent Document 2), and gold acetate in an amount smaller than that should be dissolved in water); (c) gold ions Au³⁺ dissociated from the dissolved gold acetate; and (d) acetate ions 3CH₃COO⁻ produced together with the dissociated gold ions.

It is therefore expected that when a gold carboxylate is dispersed in water, the carboxylate will be partially dissolved in water, and the remaining part will be dispersed in the form of a colloid in water, so that an equilibrium state will be reached (in the case of gold acetate, Au(OCOCH₃)₃⇄Au³⁺+3CH₃COO⁻). It is conceivable that when a carrier having a reducing power is brought into contact with the gold carboxylate in such a state, dissolved gold ions are reduced and deposited in small portions on the carrier, so that coarse particles will be less likely to form and very fine nanoparticles of gold can be deposited. It is also conceivable that as the dissolved gold ions are eliminated by the reduction, a small amount of gold ions are repeatedly dissolved from the gold carboxylate according to the solution equilibrium, so that the concentration of gold ions in the gold carboxylate dispersion can be constantly kept low.

The method of the present invention also makes it possible, at the same time, to reduce the gold carboxylate to metallic gold by the reducing power of the carrier and to deposit metallic gold on the carrier. In contrast to conventional methods, this does not require any high-temperature heat treatment for producing metallic gold by reduction, and allows simpler deposition of gold nanoparticles on the carrier.

### EXAMPLES

Hereinafter, the present invention will be more specifically described with reference to Examples and Comparative Examples, which, however, are not intended to limit the present invention.

### Test Example 1

### Preparation of Activated Carbon-Supported Gold Catalyst and Glucose Oxidation Reaction Using the Resulting Supported Catalyst

### Example 1

### Preparation of Au/Activated Carbon with 1 wt % Gold Loading

### [Preparation of Catalyst]

To 50 mL of water was added 9.6 mg of a brown powder of gold acetate (Au(CH₃COO)₃, manufactured by Alfa Aesar) and dispersed with an ultrasonic cleaner (US-2R, manufactured by AS ONE Corporation) to form a light brown dispersion. Under the above concentration conditions, a time period of 5 seconds was enough for the operation of the ultrasonic cleaner. The Tyndall effect was observed when LED light was applied to the vessel from the side. This showed that the product was not a true aqueous solution but a brown colloidal dispersion.

While the dispersion was stirred with a magnetic stirrer, 500 mg of an activated carbon powder was added to the dispersion and stirred overnight. The activated carbon was a product made from coconut shell as a raw material by water vapor activation. The activated carbon powder was prepared by grinding, in a mortar, granular activated carbon No. 034-02125 manufactured by Wako Pure Chemical Industries, Ltd. and sieving the ground product through a standard sieve with a nominal aperture size of 125 μm according to JIS Z 8801. When the stirring was stopped, the activated carbon power gradually precipitated, so that a transparent supernatant formed. This suggested that gold was deposited on the surface of the activated carbon. Subsequently, the activated carbon powder was separated by suction filtration and then washed with water. The product was placed in a drier and dried at 60° C. to give an activated carbon-supported gold catalyst with a supported gold amount of 1% by weight. In Test Example 1, the water used was distilled deionized water.

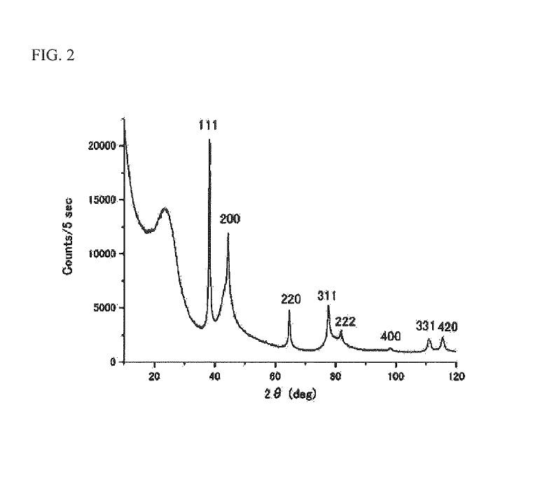

The fact that gold nanoparticles were supported on the activated carbon was shown by powder X-ray diffraction (XRD) measurement. The XRD apparatus used was MXP18 manufactured by MAC Science. The measurement conditions were as follows: CuKα X-ray with 40 kV, 200 mA, and the thin film method under=2° fixed. A reflection-free MgO (100) sample plate was used as a sample substrate. The sample powder dispersed in ethanol was applied to the sample plate and then dried. The resulting sample was subjected to the measurement. FIG. 2 shows the results. Halos (broad peaks) originated from the amorphous carbon of the activated carbon were observed at about 25°, 44°, and 79°, and metallic gold diffraction lines such as (111), (200), and (220) were clearly observed overlapping on them. This showed that metallic gold was supported. Among the diffraction lines, the half-width of the Au (111) diffraction line was used to derive the volume average particle size of the gold from calculation based on the Scherrer equation below.

D=Kλ/(B cos 0)

D: Crystallite size (corresponding to the volume average particle size)

K: Scherrer constant (K=0.849 was used in the equation)

λ: The wavelength 0.154 nm of the CuKα X-ray

B: Diffraction line width (in the equation, 0.18° was used, which was obtained by subtracting the instrumental width of 0.28° from the measured Au (111) half-width of 0.46°)

θ: Au (111) Bragg angle 19.1°

From the above equation, D was calculated to be 44.3 nm, which may be regarded as the volume average particle size of the gold nanoparticles supported on the activated carbon.

[Glucose Oxidation Reaction]

A glucose oxidation reaction was performed in water using the supported catalyst obtained by the above process. If the size of gold supported as a catalytic component is not small enough, the catalytic activity will not be observed, and a glucose oxidation reaction will not proceed. Therefore, if gluconic acid is produced by a glucose oxidation reaction, it can be estimated that small-sized gold particles are supported.

First, 6.0 g of glucose was dissolved in 104 mL of water and heated at 60° C. The pH of the solution was adjusted to 9.5 by adding a 1 mol/L sodium hydroxide aqueous solution dropwise with a dropper after the solution was bubbled with oxygen at 120 mL/min while vigorously being stirred at 1,500 rpm. In a mortar, the supported catalyst was ground into a fine powder so that the catalyst would have higher dispersibility in water. After it was checked that the pH of the glucose solution was stable, 20 mg of the fine powder was dispersed in 10 mL of water, and the dispersion was added to the glucose solution, so that a reaction was started. The reaction conditions were a glucose concentration of 5% by weight and a molar ratio of gold to glucose of 1:32,000. During the reaction, a 1 mol/L sodium hydroxide aqueous solution was automatically added dropwise under the control by a pH controller (Toko Kagaku TDP-51) so that the pH of the aqueous glucose solution would be kept within the range 9.5±0.1.

Gluconic acid produced by oxidation of glucose is neutralized with sodium hydroxide in a molar ratio of 1:1. Therefore, the gluconic acid production rate (mol s⁻¹) per reaction time (s) can be determined from the added amount (mol s⁻¹) of sodium hydroxide. When metallic gold is used as the catalytic component, only gluconic acid can be regarded as the product, and therefore, the gluconic acid production rate equals to the glucose reaction rate. It was divided by the catalyst amount (g) or the amount (mol) of metallic gold in the catalyst, so that the following two reaction rates were calculated.

R₁=R_{g}/W_{cat}

R₁: Glucose reaction rate (mol h⁻¹ g⁻¹) per weight of catalyst

R_{g}: Glucose production rate (mol h⁻¹)

W_{cat}: Catalyst weight (g)

R₂=R_{g}/M_{Au}

R₂: Glucose reaction rate (mol s⁻¹mol⁻¹) per 1 mole of metallic gold (Au) in catalyst

R_{g}: Glucose production rate (mol s⁻¹)

M_{Au}: The number (mol) of moles of Au in catalyst

Table 1 below shows the glucose oxidation reaction rate calculated after the glucose oxidation reaction was performed using the supported catalyst of Example 1. In Examples 2 to 5 and Comparative Examples 1 to 3 shown below, the glucose oxidation reaction was performed under the same conditions, and the glucose oxidation reaction rate was calculated.

### Example 2

### Study on Time Period of Contact Between Gold Acetate Dispersion and Activated Carbon

An activated carbon-supported gold catalyst with 1 wt % Au loading was obtained by performing the preparation under the same conditions as in Example 1, except that the activated carbon powder was stirred for 10 minutes after added to the gold acetate dispersion. The resulting supported catalyst was used for the glucose oxidation reaction. Table 1 below shows the glucose oxidation reaction rate. The results show that the gold acetate dispersion and the activated carbon powder do not need to be kept in contact overnight and even 10-minute contact is effective enough.

### Example 3

### Wet Kneading of Slurry of Gold Acetate Dispersion and Activated Carbon in Mortar

To an agate mortar were added 500 mg of the activated carbon powder shown in Example 1 and 9.6 mg of a gold acetate powder, and 10 drops of water was added thereto. The materials were mixed in a slurry state by grinding with an agate pestle. The slurry was gradually dried by continuous grinding for 5 minutes. Therefore, 10 drops of water was further added and then grinding was performed for 5 minutes. Immediately after this process, water was added to the slurry, and the product was subjected to suction filtration and water washing. The product was then dried at 60° C. to give an activated carbon-supported 1 wt % gold catalyst. The resulting supported catalyst was used for the glucose oxidation reaction. Table 1 below shows the glucose oxidation reaction rate. The results show that when a powdered carrier is used, a highly active catalyst can be prepared even by kneading in a slurry state.

### Example 4

### Preparation of Au/Activated Carbon with 0.1 wt % Gold Loading

To 55 mL of water was added 10.9 mg of a brown powder of gold acetate (Au(CH₃COO)₃, manufactured by Alfa Aesar) and dispersed in the same way as in Example 1 to form a brown colloidal dispersion. A 5 mL aliquot of the dispersion was diluted with water to a total volume of 50 mL. Subsequently, 500 mg of the same activated carbon powder as that used as the carrier in Example 1 was added to the dilution and stirred overnight. The product was subjected to suction filtration and water washing. The product was then dried at room temperature to give an Au/activated carbon catalyst with 0.1 wt % gold loading. The resulting supported catalyst was used for the glucose oxidation reaction. Table 1 below shows the glucose oxidation reaction rate.

### Example 5

### Preparation of Au/Activated Carbon Fiber with 1 wt % Gold Loading

In 50 mL of water was dispersed 9.6 mg of a brown powder of gold acetate (Au(CH₃COO)₃, manufactured by Alfa Aesar) in the same way as in Example 1. Subsequently, 500 mg of fibrous activated carbon (FR15 manufactured by KURARAY CHEMICAL CO., LTD.), which had been washed with hot water in advance, was added to the dispersion. The dispersion was stirred overnight with a shaker and then subjected to suction filtration and water washing. The product was dried at room temperature to give a Au/activated carbon catalyst with 1 wt % gold loading. The resulting supported catalyst was used for the glucose oxidation reaction. Table 1 below shows the glucose oxidation reaction rate.

### Comparative Example 1

### Preparation of Supported Catalyst by Contact with Carrier After Preparation of Gold Colloid

In 10 mL of water was dispersed 10.5 mg of a brown powder of gold acetate (Au(CH₃COO)₃, manufactured by Alfa Aesar) in the same way as in Example 1. Under stirring with a magnetic stirrer, 10 mL of ethanol was added to the dispersion and heated at about 60° C. for 10 minutes, so that gold ions in the gold acetate were entirely reduced by the ethanol to form a red gold colloid. After the heating was stopped and the product was cooled to room temperature, 30 mL of water was added to the product to give a total volume of 50 mL.

Subsequently, 500 mg of the same activated carbon powder as that used as the carrier in Example 1 was added to the product and stirred overnight. The product was then subjected to suction filtration and water washing. Subsequently, the product was dried at 60° C. to give a Au/activated carbon catalyst with 1 wt % gold loading. The resulting supported catalyst was used for the glucose oxidation reaction. Table 1 below shows the glucose oxidation reaction rate.

### Comparative Example 2

### Use of Neutralized Chloroauric Acid as Gold Precursor

A solution was prepared under the same conditions as in Example 1, except that crystals of chloroauric acid tetrahydrate (KISHIDA CHEMICAL Co., Ltd.) was weighed instead of gold acetate with an electronic balance and dissolved in a certain amount of water and 0.26 mL of the resulting 0.1 mol/L chloroauric acid (HAuCl₄) aqueous solution was used. The color of the chloroauric acid aqueous solution as prepared was yellow (the normal color of a chloroauric acid aqueous solution), and no Tyndall effect was observed. The chloroauric acid was completely dissolved to form a true solution. The chloroauric acid aqueous solution was heated at 60° C., to which NaOH was added dropwise, so that a transparent [Au(OH)₃Cl]⁻ solution with a pH of 7.8 was obtained. The same activated carbon powder (500 mg) as that used as the carrier in Example 1 was added to the solution. The mixture was stirred overnight under the same conditions as in Example 1. The product was then subjected to filtration and water washing. Subsequently, the product was dried to give an activated carbon-supported 1 wt % gold catalyst. The resulting supported catalyst was used for the glucose oxidation reaction. Table 1 below shows the glucose oxidation reaction rate.

### Comparative Example 3

### Preparation of Activated Carbon-Supported 0.1 wt % Gold from Chloroauric Acid

The same 0.1 mol/L chloroauric acid aqueous solution as used in Comparative Example 2 was diluted 1/100 with distilled deionized water to form a 1 mmol/L chloroauric acid aqueous solution. The solution was added to 50 mL of distilled deionized water. Subsequently, 500 mg of the same activated carbon powder as that used as the carrier in Example 1 was added to the solution and stirred overnight. The product was then subjected to suction filtration and water washing. Subsequently, the product was dried at room temperature to give an activated carbon-supported 0.1 wt % gold catalyst. The resulting supported catalyst was used for the glucose oxidation reaction. Table 1 below shows the glucose oxidation reaction rate.

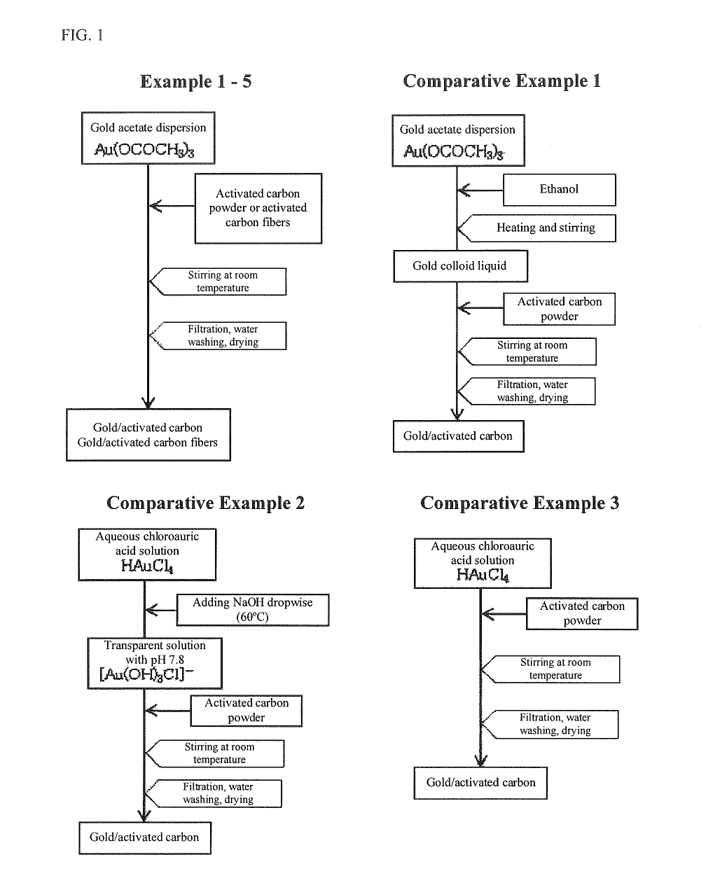

Among the above, the preparation process in each of Examples 1 to 5 and Comparative Examples 1 to 3 is shown in the flow chart of FIG. 1.

Table 1 below shows the glucose oxidation reaction rate calculated after the glucose oxidation reaction was performed using each of the supported catalysts prepared in Examples 1 to 5 and Comparative Examples 1 to 3.

TABLE 1

| | | | | Glucose oxida- | |
|---|---|---|---|---|---|
| | | | | tion rate (60° C.) | |
| | | | Au | R₁ | R₂ |
| | | Gold | loading | mol h⁻¹ g | mol s⁻¹ |
| | Catalyst | precursor | (wt %) | catalyst⁻¹ | mol_{Au}⁻¹ |
| Example 1 | Au/activated | Gold acetate | 1.0 | 0.99 | 5.41 |
| | carbon | | | | |
| Example 2 | Au/activated | Gold acetate | 1.0 | 1.29 | 7.08 |
| | carbon | | | | |
| Example 3 | Au/activated | Gold acetate | 1.0 | 1.42 | 7.79 |
| | carbon | | | | |
| Example 4 | Au/activated | Gold acetate | 0.1 | 0.22 | 11.9 |
| | carbon | | | | |
| Example 5 | Au/activated | Gold acetate | 1.0 | 0.11 | 0.60 |
| | carbon fibers | | | | |
| Comparative | Au/activated | Gold colloid | 1.1 | 0.04 | 0.19 |
| Example 1 | carbon | | | | |
| Comparative | Au/activated | Chloroauric | 1.0 | 0.09 | 0.51 |
| Example 2 | carbon | acid | | | |
| Comparative | Au/activated | Chloroauric | 0.1 | 0.00 | 0.02 |
| Example 3 | carbon | acid | | | |

Table 1 shows that the activated carbon-supported gold catalysts of Examples 1 to 3 prepared by the method of the present invention each showed higher catalytic activity for glucose oxidation than that of Comparative Example 1 or 2 where the same amount 1 wt % was added in the preparation, and each have higher catalytic activity for glucose oxidation reaction. The catalytic activity was low particularly in Comparative Example 1. This may be because in Comparative Example 1, the carrier is added after the liquid-phase growth of colloidal gold particles are completed (in other words, after the precursor is reduced to metallic gold), so that the product contains almost no fine particles of gold (e.g., 10 nm or less in average particle size). In Comparative Example 2, high activity was not obtained. This may be because in Comparative Example 2, the carrier comes into contact with a high concentration of gold ions in the solution, so that gold fine particles (e.g., 10 nm or less in average particle size) are less likely to form, and chloride ions also coexist in the solution.

The glucose oxidation reaction conditions used in Test Example 1 are the same as those described in Hiroko Okatsu et al., Applied Catalysis A: General, 369 (2009) 8-14. Specifically, in the test according to Hiroko Okatsu et al., the glucose oxidation reaction using each of Au catalysts supported on different carbon materials was performed under the following conditions: a molar ratio of glucose to gold of 16,000 to 32,000, a reaction temperature of 60° C., and at a pH of 9.5. They also showed the relationship between the particle size of the supported gold and the reaction rate per amount of the supported gold. According to them, when the catalytic activity per 1 mole of metallic gold in the supported catalyst was 1 mol s⁻¹mol_{Au}⁻¹ or more, the average particle size of the supported gold can be estimated as 10 nm or less. Therefore, if R₂ is 1 mol s⁻¹mol_{Au}⁻¹ or more in the present test, it can be estimated that a large number of particles with an average particle size of 10 nm or less are present.

On the other hand, the XRD measurement showed that the gold nanoparticles in the supported catalyst of Example 1 have a volume average particle size of 44.3 nm. In the XRD profile used to determine the average particle size, however, peaks derived from coarse particles are dominant, even if in a minute amount, and can mask peaks derived from fine particles. Therefore, on the basis of the reaction rate calculated from the glucose oxidation reaction, the supported catalyst of Example 1 is estimated to be a mixture of a small number of relatively large gold particles with sizes of several 10 nm and a large number of gold nanoparticles with sizes of 10 nm or less. It is also estimated from the R₂ values that gold nanoparticles with a size of 10 nm or less were supported in Examples 2 to 4.

When the nominal loading of gold was reduced to 0.1% in Example 4 using the method of the present invention, the reaction rate per mole of gold significantly increased. In contrast, the activity is very low in Comparative Example 3 where the catalyst is prepared from chloroauric acid. This suggests that almost no fine particles of gold are produced.

In Example 5 using activated carbon fibers, the resulting activity was significantly higher than that in Comparative Example 3 although it was somewhat lower than that in Examples 1 to 4. This shows that the method of the present invention also makes it possible to deposit gold fine nanoparticles with an average particle size of 10 nm or less on carbon materials in a form other than powder.

### Test Example 2

### Preparation of Gold/Titanium Oxide Catalyst and Carbon Monoxide (CO) Oxidation Reaction using the Resulting Supported Catalyst

### Example 6

### Preparation of Titanium Oxide-Supported Gold Catalyst

### [Preparation of Supported Catalyst]

To 50 mL of water was added 9.6 mg of a brown powder of gold acetate (Au(CH₃COO)₃, manufactured by Alfa Aesar) to form a colloidal gold acetate dispersion in the same manner as in Example 1.

While the dispersion was stirred with a magnetic stirrer, 500 mg of a white powder of titanium oxide (P25 manufactured by NIPPON AEROSIL CO., LTD.) was added to the dispersion and stirred overnight. The suspension was first whitish light brown and then turned into almost white after 3 hours. The stirring was continued for 24 hours and then stopped. At this point, the product was light purple. This color was almost the same as that in a case where about 3 nm gold nanoparticles were deposited on the surface of titanium oxide by deposition precipitation method. It was therefore suggested that gold nanoparticles were successfully deposited from the gold acetate colloid. After separated by filtration and washed with water, the product was dried to give a titanium oxide-supported 1.0 wt % gold catalyst. In Test Example 2, the water used was distilled deionized water.

[Carbon Monoxide Oxidation Reaction]

In the presence of the resulting catalyst, a carbon monoxide oxidation reaction was performed at room temperature (25° C.) using a fixed bed flow reactor (manufactured by Ohkura Riken Co., Ltd. (now HEMMI Slide Rule Co., Ltd.)), and the catalytic activity was evaluated. A quartz reaction tube with an inner diameter of 6 mm was charged with a mixture of 20 mg of the supported catalyst powder and 0.5 g of quartz sand. A mixed gas of CO (1%), O₂ (20%), and He (balance gas) was allowed to flow at 100 mL/min through the reaction tube, and the gas at the outlet of the reaction tube was analyzed with a photo-acoustic spectrometer (PAS) (manufactured by Luma Sense Technologies Inc.). Thirty minutes after the reaction was started, the concentrations of CO and CO₂ stabilized. Therefore, the CO conversion ratio was calculated from the analysis values by the procedure below and converted into the reaction rate. Table 2 shows the resulting values.

Y_{CO2}=(C_{CO2}/Ci_{CO})×100

Y_{CO2}: The CO conversion to CO₂ (%)

C_{CO2}: CO₂ concentration (%) at the outlet of the reaction tube

Ci_{CO}: CO concentration (1%) at the inlet of the reaction tube

Fi_{CO}=Fa×(Ci_{CO}/100)

=2.68×10⁻³ mol h⁻¹

=7.44×10⁻⁷ mol s⁻¹

Fi_{CO}: CO flow rate at the inlet of the reaction tube

Fa: Total gas flow rate at the inlet of the reaction tube

(100 mL/min, 0.268 mol/h as expressed in moles)

Ci_{CO}: CO concentration (1%) at the inlet of the reaction tube

R_{CO}=Fi_{CO}×(Y_{CO2}/100)

R_{CO}: CO reaction rate (mol h⁻¹ or mol s⁻¹)

Y_{CO2}: The CO conversion to CO₂ (%)

R₁=R_{CO}/W_{cat}

R₁: CO reaction rate (mol h⁻¹ g⁻¹) per weight of the catalyst

R_{CO}: CO reaction rate (mol h⁻¹)

W_{cat}.: Catalyst weight (g)

R₂=R_{CO}/M_{Au}

R₂: CO reaction rate (mol s⁻¹ mol⁻¹) per 1 mole of metallic gold (Au) in the catalyst

R_{CO}: CO reaction rate (mol s⁻¹)

M_{Au}: The moles of Au in the catalyst (mol)

### Example 7

### Preparation of Titanium Oxide-Supported Cold Catalyst using Reducing Agent)

To 25 mL of water was added 9.6 mg of a brown powder of gold acetate (Au(CH₃COO)₃, manufactured by Alfa Aesar) to form a colloidal gold acetate dispersion in the same manner as in Example 1.

While the dispersion was stirred with a magnetic stirrer, 500 mg of a white powder of titanium oxide (P25 manufactured by NIPPON AEROSIL CO., LTD.) was added to the dispersion, and then 25 mL of ethanol was immediately added. The suspension was first whitish light brown and then turned into light purple after 40 minutes (the same color as that obtained after stirring for a day in Example 5). The stirring was stopped in 1 hour. During this process, the production of a red gold colloid as in Comparative Example 1 was not observed at all. After separated by filtration and washed with water, the product was dried to give a titanium oxide-supported 1.0 wt % gold catalyst. The CO oxidation reaction rate was measured by the same method as shown in Example 6. Table 2 shows the results.

As shown in Comparative Example 1, when ethanol was used as a reducing agent to completely reduce gold acetate to a gold colloid in a liquid phase and then a carrier was added to the gold colloid, the catalytic activity was almost lost relative to that in Example 1. In contrast, when ethanol was added as a reducing agent to the colloidal gold acetate dispersion as in this example, the catalytic activity was not significantly decreased relative to that in Example 6, and the deposition of gold on the surface of the carrier was successfully completed in a very short time.

### Example 8

### Preparation of Titanium Oxide-Supported Gold Catalyst Using Reducing Agent and Protective Colloid

To 50 mL of water was added 19.5 mg of a brown powder of gold acetate (Au(CH₃COO)₃, manufactured by Alfa Aesar), and 565 mg of PVP was further added as a protective colloid, so that a colloidal gold acetate dispersion was obtained similarly to Example 1.

While the dispersion was stirred with a magnetic stirrer, 500 mg of a white powder of titanium oxide (P25 manufactured by NIPPON AEROSIL CO., LTD.) was added to the dispersion, and 32.1 mg of magnesium citrate was added as a reducing agent. The suspension was first whitish light brown and then turned into light purple gray after stirring overnight. As the stirring was stopped, a precipitate quickly formed, and the supernatant was completely clear. During filtration, the water passed smoothly, and washing with water was performed in a time shorter than in Example 6. After dried, the precipitate was calcined at 350° C. for 30 minutes to give a light-purple, titanium oxide-supported gold catalyst. After acid dissolution, ICP-AES analysis (with an inductively coupled plasma spectrometer) was performed. The amount of the supported metallic gold was determined to be 1.2% by weight. A comparison with 1.0% nominal loading by weight calculated from the added amount of the raw material shows no decrease in the amount of gold. It is therefore conceivable that almost the whole amount of the added metallic gold was deposited on the surface of titanium oxide.

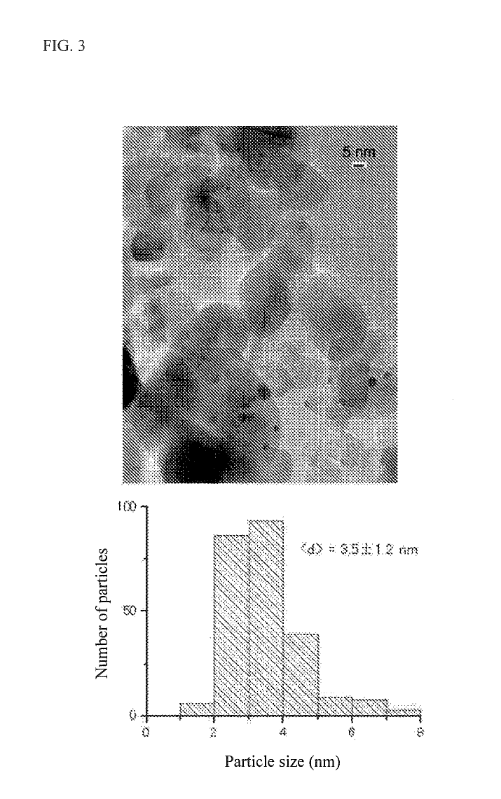

FIG. 3 shows a transmission electron microscope (TEM) photograph of the resulting gold/titanium oxide and the gold nanoparticle size distribution based on the TEM photograph. The number average size of the gold nanoparticles was 3.5 nm, and the coexistence of large particles of 10 nm or more was not observed. The catalytic activity for the carbon monoxide oxidation reaction was evaluated as in Example 6. Table 2 shows the results. The supported catalyst obtained in Example 8 had catalytic activity higher than that in Example 6.

### Comparative Example 4

### Use of Chloroauric Acid as Gold Precursor

A supported catalyst was prepared using the same process as in Example 6 except that chloroauric acid was used instead of gold acetate. First, 0.26 mL of a 0.1 mol/L chloroauric acid aqueous solution was added to 50 mL of water to form a light yellow aqueous solution.

While the aqueous solution was stirred with a magnetic stirrer, 500 mg of a white powder of titanium oxide (P25 manufactured by NIPPON AEROSIL CO., LTD.) was added to the solution and stirred for 24 hours. The color of the suspension did not change from the original color, yellowish milky white. This suggested that no reduction occurred on the surface. After separated by filtration and washed with water, the product was dried at room temperature to give a milky white supported catalyst. The amount of supported gold calculated from the added value corresponds to 1.0% by weight.

TABLE 2

| | | | | | CO oxidation reaction rate | |
|---|---|---|---|---|---|---|
| | | | | | (room temperature) | |
| | | Gold | Reducing | Au loading | R₁ | R₂ |
| | Catalyst | precursor | agent | (wt %) | mol h⁻¹ g catalyst⁻¹ | mol s⁻¹ mol_{Au}⁻¹ |
| Example 6 | Au/titanium oxide | Gold | Absent | 1.0 | 0.0084 | 0.046 |
| | | acetate | | | | |
| Example 7 | Au/titanium oxide | Gold | Ethanol | 1.0 | 0.0058 | 0.032 |
| | | acetate | | | | |
| Example 8 | Au/titanium oxide | Gold | Magnesium | 1.0 | 0.024 | 0.13 |
| | | acetate | citrate | | | |
| Comparative | Au/titanium oxide | Chloroauric | Absent | 1.0 | 0.00071 | 0.0039 |
| Example 4 | | acid | | | | |

As shown in Table 2, also when titanium oxide was used as the carrier, the resulting supported gold nanoparticle catalysts had catalytic activity as high as that in the case of using activated carbon as the carrier.

In this regard, Hironori Ohashi, Gold Nanotechnology, Gold Nanotechnology: Fundamentals and Applications, Chapter 8, Supervised by Masatake Haruta, CMC Publishing, pp. 220-234 (2009) shows the relationship between the gold particle size of a gold/titanium oxide catalyst in CO oxidation at a reaction temperature of 0° C. and TOF (turn over frequency (the reaction rate per one surface atom of gold (Au) particles supported on the carrier surface)). The titanium oxide and the reactant gas CO concentration (1%) and O₂ concentration (20%) in the carbon monoxide oxidation reaction shown in this literature are the same as those in the examples according to the present invention.

The TOF can be calculated if the reaction rate per weight of the catalyst, the amount of supported gold in the catalyst, and the average particle size of gold are known. According to the literature, the TOF is about 0.015 s⁻¹ when the gold particle size is 10 nm, and Au atoms exposed to the surface of 10 nm spherical Au particles make up about 10% of all the Au particles. When calculated backwards from these values, the reaction rate per 1 mole of supported Au corresponds to 0.0015 mol s⁻¹mol_{Au}⁻¹. In the literature, the reaction temperature is 0° C. If the above reaction rate is converted into the reaction rate at 25° C. using the value 34 kJ/mol, which is reported as the activation energy of Au/titanium oxide at room temperature or lower, it is 0.0053 mol s⁻¹ mol_{Au}⁻¹. Therefore, it can be estimated that the average particle size of supported gold is 10 nm or less in the case that the reaction rate is 0.0053 mol s⁻¹ mol_{Au}⁻¹ or more under the reaction conditions used in Test Example 2.

It is estimated from this that the supported gold nanoparticles in the supported catalysts of Examples 6 to 8 have an average particle size of 10 nm or less. The average particle size in Example 8 was actually determined to be 3.5 nm from the TEM size distribution. On the other hand, it is estimated that the average particle size of Au in Comparative Example 4 is larger than 10 nm, because R₂ is smaller than 0.0053 mol s⁻¹ mol_{Au}⁻¹.

Therefore, it has been shown that according to the present invention, a supported catalyst including supported gold nanoparticles with an average particle size of 10 nm or less can be obtained also when titanium oxide is used as a carrier.

### Test Example 3

### Preparation of Gold/Cobalt Oxide Catalyst and Gold/Manganese Oxide Catalyst and Carbon Monoxide (CO) Oxidation Reaction using the Resulting Supported Catalysts

### Example 9

### Preparation of Cobalt Oxide-Supported Gold Catalyst

A cobalt oxide powder prepared by a precipitation method was used in the preparation of the supported catalyst. Sodium carbonate in an amount 1.2 times the neutralization equivalent was added to an aqueous cobalt nitrate solution, so that cobalt hydroxide was precipitated. The precipitate was washed with water, separated by filtration, and dried. Subsequently, the precipitate was calcined in an electric furnace at 400° C. for 4 hours, so that a black powder of cobalt oxide was obtained. To 50 mL of water was added 10 mg of a brown powder of gold acetate (Au(CH₃COO)₃, manufactured by Alfa Aesar) to form a colloidal gold acetate dispersion in the same manner as in Example 1. While the dispersion was stirred with a magnetic stirrer, 500 mg of the cobalt oxide powder was added to the dispersion and stirred overnight. Even when the stirring was stopped, no precipitate formed. Therefore, the dispersion was transferred to a centrifuge tube—made of PFA and then centrifuged at a speed of 4,000 rpm for 10 minutes in a centrifugal separator. The upper dilute suspension was discarded while the precipitate slurry was left in the centrifuge tube. Water was added in the same amount as discarded, and a second centrifugal separation was performed under the same conditions as in the first separation. This process was repeated four times in total, and the precipitate was cleaned. The precipitate was dried at room temperature to give a cobalt oxide-supported 1.0 wt % gold catalyst. The water used in Test Example 3 was distilled deionized water. The CO oxidation reaction rate was measured by the same method as shown in Example 6. Table 3 shows the results.

### Comparative Example 5

### Use of Cobalt Oxide Carrying no Gold

A cobalt oxide powder was prepared as in Example 9. The cobalt oxide was directly used as a catalyst without deposition of gold. The CO oxidation reaction rate was measured by the same method as shown in Example 6. Table 3 shows the results.

### Example 10

### Preparation of Manganese Oxide-Supported Gold Catalyst

To 50 mL of water was added 10 mg of a brown powder of gold acetate (Au(CH₃COO)₃, manufactured by Alfa Aesar) to form a colloidal gold acetate dispersion in the same manner as in Example 1. While the dispersion was stirred with a magnetic stirrer, 500 mg of a manganese dioxide powder was added to the dispersion and stirred overnight. The manganese dioxide powder was prepared by grinding, in a mortar, granular manganese dioxide manufactured by KISHIDA CHEMICAL Co., Ltd. for elementary analysis of organic substances and sieving the ground product through a standard sieve with a nominal aperture size of 125 μm according to JIS Z 8801. As the stirring was stopped, the manganese dioxide powder gradually precipitated, and the supernatant became clear. This suggested that gold was deposited on the manganese dioxide surface. Subsequently, the manganese dioxide powder was subjected to suction filtration and water washing. The product was dried at room temperature to give a manganese oxide-supported 1 wt % gold catalyst.

### Comparative Example 5

### Use of Cobalt Oxide Without Gold

A cobalt oxide powder was prepared as in Example 9. The cobalt oxide was directly used as a catalyst without deposition of gold. The CO oxidation reaction rate was measured by the same method as shown in Example 6. Table 3 shows the results.

TABLE 3

| | | | | CO oxidation | |
|---|---|---|---|---|---|
| | | | | reaction rate | |
| | | | | (room temperature) | |
| | | | Au | R₁ | R₂ |
| | | Gold | loading | mol h⁻¹ g | mol s⁻¹ |
| | Catalyst | precursor | (wt %) | catalyst⁻¹ | mol_{Au}⁻¹ |
| Example 9 | Au/manganese | Gold | 1.0 | 0.0041 | 0.023 |
| | oxide | acetate | | | |
| Example 10 | Au/cobalt | Gold | 1.0 | 0.0145 | 0.080 |
| | oxide | acetate | | | |
| Comparative | Manganese | | 0 | 0.0000 | |
| Example 5 | oxide | | | | |
| Comparative | Cobalt | | 0 | 0.0014 | |
| Example 6 | oxide | | | | |

As shown in Table 3, also when an oxide containing a low-valent transition metal ion, such as manganese oxide or cobalt oxide, was used as the carrier, the deposition of gold by the method of the present invention successfully provided supported gold nanoparticles having high catalytic activity. When manganese oxide with no deposited gold was used, no CO oxidation activity was observed at room temperature. It is known that if in a dry state, cobalt oxide can have CO oxidation activity at room temperature even without depositing gold. However, when gold was deposited by the method of the present invention, the CO oxidation activity per weight of the catalyst increased to at least 10 times. The R₂ value is larger than 0.0053 mol s⁻¹mol_{Au}⁻¹ in both Examples 9 and 10. Therefore, it is also estimated that the average particle size of Au is less than 10 nm.

1. A supported catalyst comprising: a carrier having a reducing power; and gold nanoparticles with an average particle size of 100 nm or less supported on the carrier.

2. The supported catalyst according to claim 1, wherein the gold nanoparticles have an average particle size of 10 nm or less.

3. The supported catalyst according to claim 1, wherein the carrier having a reducing power is a porous material.

4. The supported catalyst according to claim 2, wherein the carrier having a reducing power is a porous material.

5. The supported catalyst according to claim 1, wherein the carrier having a reducing power is a carbon material or a metal oxide.

6. The supported catalyst according to claim 2, wherein the carrier having a reducing power is a carbon material or a metal oxide.

7. The supported catalyst according to claim 3, wherein the carrier having a reducing power is a carbon material or a metal oxide.

8. The supported catalyst according to claim 4, wherein the carrier having a reducing power is a carbon material or a metal oxide.

9. The supported catalyst according to claim 1, wherein the carrier having a reducing power is at least one selected from the group consisting of powdered activated carbon, fibrous activated carbon, titanium oxide, cobalt oxide, and manganese oxide.

10. A method for producing a supported catalyst comprising supported gold nanoparticles with an average particle size of 100 nm or less, the method comprising the step of bringing a gold carboxylate and a carrier having a reducing power into contact with each other in the presence of water.

11. The method according to claim 10, which comprises the steps of:
(i) dispersing the gold carboxylate in water to form a colloidal gold carboxylate dispersion; and
(ii) bringing the colloidal gold carboxylate dispersion obtained in the step (i) and the carrier having a reducing power into contact with each other to deposit gold nanoparticles on the carrier.

12. The method according to claim 11, wherein in the step (ii), a reducing agent is further added to the colloidal gold carboxylate dispersion.

13. The method according to claim 11, wherein in the step (ii), a protective colloid is further added to the colloidal gold carboxylate dispersion.

14. The method according to claim 12, wherein in the step (ii), a protective colloid is further added to the colloidal gold carboxylate dispersion.

15. The method according to claim 1, wherein the gold carboxylate is gold acetate.
